(19) United States
(12) Patent Application Publication
(10) Pub. No.: US 2016/0114668 A1
(43) Pub. Date: Apr. 28, 2016

(54) HYDROSTATIC-PARALLEL HYDRAULIC HYBRID ARCHITECTURES

(71) Applicant: Parker-Hannifin Corporation, Cleveland, OH (US)

(72) Inventors: Hao ZHANG, Twinsburg, OH (US); Raymond COLLETT, Put in Bay, OH (US); Rajneesh KUMAR, Mayfield Heights, OH (US)

(21) Appl. No.: 14/980,771

(22) Filed: Dec. 28, 2015

Related U.S. Application Data
(63) Continuation of application No. PCT/US2014/043762, filed on Jun. 24, 2014.
(60) Provisional application No. 61/839,113, filed on Jun. 25, 2013.

(51) Int. Cl. B60K 6/12; F16H 61/44; F16H 47/04

(52) U.S. Cl. CPC B60K 6/12; F16H 47/04; F16H 61/44; F16H 2047/045

(57) ABSTRACT

Provided is a hydrostatic system including a first hydraulic unit, second and third hydraulic units fluidly connected to the first hydraulic unit, and a hydraulic accumulator fluidly connected to the first hydraulic unit and the third hydraulic unit, where the hydrostatic system is selectively coupleable to a prime mover and/or one or more wheels. The hydrostatic system may be operated in a hydrostatic driving mode where the hydraulic accumulator is isolated from the system and the first hydraulic unit drives the second and third hydraulic units, and in a hybrid driving mode where the hydraulic accumulator supplies fluid to the third hydraulic unit and the first hydraulic unit supplies or does not supply fluid to the second hydraulic unit. By selectively coupling the hydrostatic system to the prime mover, the hydrostatic system and the prime mover may be operated independent of one another. By selectively coupling the hydrostatic system to the wheels, the hydrostatic system and the wheels may be operated independent of one another.

### RELATED APPLICATIONS

This application is a continuation of International Application No. PCT/US2014/043762 filed Jun. 24, 2014 and published in the English language, which claims the benefit of U.S. Provisional Application No. 61/839,113 filed Jun. 25, 2013, which are hereby incorporated herein by reference.

### FIELD OF INVENTION

The present invention relates generally to a vehicle having a hydrostatic transmission, and more particularly to a vehicle having a hydrostatic hybrid transmission.

### BACKGROUND

Drive train systems are widely used for generating power from a source and for transferring such power from the source to a driven mechanism. Frequently, the source generates rotational power, and such rotational power is transferred from the source of rotational power to a rotatably driven mechanism. For example, in most land vehicles in use today, an engine generates rotational power, and such rotational power is transferred from an output shaft of the engine through a driveshaft to an input shaft of an axle so as to rotatably drive the wheels of the vehicle.

In some vehicles and other mechanisms, a hybrid drive system is provided in conjunction with the drive train system for accumulating energy during braking of the rotatably driven mechanism and for using such accumulated energy to assist in subsequently rotatably driving the rotatably driven mechanism. To accomplish this, a typical hybrid drive system includes an energy storage device and a reversible energy transfer machine. The reversible energy transfer machine communicates with the energy storage device and is mechanically coupled to a portion of the drive train system. Typically, the hybrid drive system can be operated in either a retarding mode, a neutral mode, or a driving mode. In the retarding mode, the reversible energy transfer machine of the hybrid drive system accumulates energy by braking or otherwise retarding the rotatably driven mechanism of the drive train system and stores such energy in the energy storage device. In the neutral mode, the hydraulic drive system is disconnected from the drive train system and, therefore, is substantially inoperative to exert any significant driving or retarding influence on the rotatably driven mechanism. In the driving mode, the reversible energy transfer machine of the hybrid drive system supplies the accumulated energy previously stored in the energy storage device to assist in subsequently rotatably driving the rotatably driven mechanism.

### SUMMARY OF INVENTION

The present invention provides a hydrostatic system including a first hydraulic unit, second and third hydraulic units fluidly connected to the first hydraulic unit, and a hydraulic accumulator fluidly connected to the first hydraulic unit and the third hydraulic unit, where the hydrostatic system is selectively coupleable to a prime mover and/or one or more wheels. The hydrostatic system may be operated in a hydrostatic driving mode where the hydraulic accumulator is isolated from the system and the first hydraulic unit drives the second and third hydraulic units, and in a hybrid driving mode where the hydraulic accumulator supplies fluid to the third hydraulic unit and the first hydraulic unit supplies or does not supply fluid to the second hydraulic unit. By selectively coupling the hydrostatic system to the prime mover, the hydrostatic system and the prime mover may be operated independent of one another. By selectively coupling the hydrostatic system to the wheels, the hydrostatic system and the wheels may be operated independent of one another.

In an embodiment, the hydrostatic system may drive the wheels at multiple speed ranges.

The invention also provides hydraulic and hydrostatic systems and powertrains having features which are set out in the following numbered clauses:

Clause 1: A hydrostatic system including a first hydraulic unit configured to be driven by a prime mover, a first shaft, a second shaft that that is selectively coupleable to the first shaft through a first pair of gears, and that is connectable to one or more wheels, a second hydraulic unit mounted on the first shaft and being fluidly connected to the first hydraulic unit, a third hydraulic unit mounted on the first shaft and being fluidly connected to the first hydraulic unit, and a hydraulic accumulator fluidly connected to the first hydraulic unit and the third hydraulic unit.

Clause 2: The hydrostatic system according to clause 1, further including a controller configured to cause the third hydraulic unit to be driven by fluid from the accumulator at the same time that the second hydraulic unit is driven by fluid from the first hydraulic unit.

Clause 3: The hydrostatic system according to clause 1 or 2, wherein the second and third hydraulic units each have a first side fluidly connected to a first side of the first hydraulic unit, and wherein the first side of the third hydraulic unit is fluidly connected to the hydraulic accumulator.

Clause 4: The hydrostatic system according to any preceding clause, wherein the second hydraulic unit has a second side fluidly connected to a second side of the first hydraulic unit for driving the first shaft in reverse.

Clause 5: The hydrostatic system according to any preceding clause, wherein the first hydraulic unit has a second side fluidly connected to the hydraulic accumulator.

Clause 6: The hydrostatic system according to any preceding clause, further including a valve between the accumulator and the first side of the third hydraulic unit for isolating the accumulator from the third hydraulic unit during a hydrostatic driving condition and for allowing fluidic communication between the accumulator and third hydraulic unit during a hybrid driving condition.

Clause 7: The hydrostatic system according to clause 6, wherein the valve is an on/off check valve.

Clause 8: The hydrostatic system according to clause 7, further including a directional control valve between the on/off check valve and the third hydraulic unit, wherein the directional control valve allows for fluid storage in the accumulator in forward and reverse.

Clause 9: The hydrostatic system according to any of clauses 1-7 further including a valve between the first side of the first hydraulic unit and the hydraulic accumulator, wherein when the valve is open the accumulator and the first side of the first hydraulic unit are fluidly connected.

Clause 10: The hydrostatic system according to any of clauses 1-7, further including a fourth hydraulic unit fluidly connected to the second and third hydraulic units, wherein the first and fourth hydraulic units are mounted on a third shaft driven by the prime mover.

Clause 11: The hydrostatic system according to clause 10, further including a directional control valve between a first side of the first hydraulic unit and the hydraulic accumulator selectively connecting the first hydraulic unit to the hydraulic accumulator to charge the hydraulic accumulator.

Clause 12: The hydrostatic system according to clause 10 or 11, wherein the third shaft is rotatable to drive the first hydraulic unit to charge the accumulator and to drive the fourth hydraulic unit to pump fluid to the second and third hydraulic units.

Clause 13: The hydrostatic system according to any of clauses 1-7, further including a directional control valve between the first side of the second hydraulic unit and the first side of the third hydraulic unit, wherein the directional control valve is configured to isolate the third hydraulic unit from fluid flowing from the first hydraulic unit in a first state, and allow fluid flow from the first hydraulic unit to the third hydraulic unit in a second state.

Clause 14: The hydrostatic system according to any preceding clause, further including a controller configured to cause the third hydraulic unit to be driven in tandem with the second hydraulic unit by fluid from the first hydraulic unit in a first operation mode, cause the third hydraulic unit to be driven by fluid from the hydraulic accumulator when the second hydraulic unit is not driven in a second operation mode, and cause the third hydraulic unit to be driven by fluid from the accumulator at the same time that the second hydraulic unit is driven by fluid from the first hydraulic unit in a third operation mode.

Clause 15: The hydrostatic system according to any preceding clause, wherein the hydraulic units are hydraulic pumps/motors.

Clause 16: The hydrostatic system according to clause 15, wherein the hydraulic pump/motors are bi-directional pumps/motors

Clause 17: A hydrostatic system including a first shaft coupleable to a prime mover, a first hydraulic pump/motor mounted on the first shaft, a second hydraulic pump/motor mounted on the first shaft, a second shaft, a third shaft that is selectively coupleable to the second shaft through a first pair of gears, and that is connectable to one or more wheels, a third hydraulic pump/motor mounted on the second shaft and being fluidly connected to the first and second hydraulic pumps/motors, a fourth hydraulic pump/motor mounted on the second shaft and being fluidly connected to the first and second hydraulic pumps/motors, and a hydraulic accumulator fluidly connected to the first hydraulic pump/motor and the fourth hydraulic pump/motor.

Clause 18: The hydrostatic system according to clause 17, further including a directional control valve between a first side of the first hydraulic pump/motor and the hydraulic accumulator for selectively connecting the first hydraulic pump/motor to the hydraulic accumulator to charge the hydraulic accumulator or to the third and fourth hydraulic pumps/motors to drive the pumps/motors.

Clause 19: The hydrostatic system according to clause 18, whereby when the first and second hydraulic pumps/motors are driven by rotation of the first shaft and the directional control valve connects the first hydraulic pump/motor to the hydraulic accumulator, the first hydraulic pump/motor charges the accumulator and the second hydraulic pump/motor drives the third and fourth pump/motors.

Clause 20: The hydrostatic system according to clause 17 or 18, wherein the first shaft is rotatable to drive the first hydraulic pump/motor to charge the accumulator and to drive the second hydraulic pump/motor to pump fluid to the third and fourth hydraulic pumps/motors.

Clause 21: The hydrostatic system according to any preceding clause, further including a controller for controlling the directional control valve.

Clause 22: The hydrostatic system according to any preceding clause, further including an on/off check valve between the hydraulic accumulator and a first side of the fourth hydraulic pump/motor for isolating the accumulator from the fourth hydraulic pump/motor during a hydrostatic driving condition and for allowing fluidic communication between the hydraulic accumulator and fourth hydraulic pump/motor during a hybrid driving condition.

Clause 23: A powertrain for transmitting power between a prime mover and at least one drive wheel, the powertrain including a first shaft rotatably coupled to the prime mover, a second shaft coupled to the at least one drive wheel and selectively coupled to the first shaft, a first hydraulic unit selectively coupled to the first shaft through a first pair of gears, second and third hydraulic units each mounted on a third shaft that is selectively coupled to the second shaft through a second pair of gears, a hydraulic circuit fluidly connecting the first hydraulic unit to the second and third hydraulic units, and a hydraulic accumulator fluidly connected to the hydraulic circuit.

Clause 24: The powertrain according to clause 23, wherein the hydraulic accumulator is fluidly connected to the first hydraulic unit and the third hydraulic unit through the hydraulic circuit.

Clause 25: The powertrain according to clause 23 or 24, wherein the first shaft is selectively coupled to the second shaft by a first clutch.

Clause 26: The powertrain according to any preceding clause, wherein the second shaft is selectively coupled to the third shaft by second or third clutches.

Clause 27: The powertrain according to any preceding clause, wherein the first hydraulic unit is selectively coupled to the first shaft by a fourth clutch.

Clause 28: The powertrain according to clause 23 or 24, wherein the second shaft and the first hydraulic unit are coupled to the first shaft by a planetary gear set.

Clause 29: The powertrain according to clause 28, wherein the planetary gear set includes a carrier gear coupled to the first shaft, a sun gear coupled to the first hydraulic unit that is rotated by the carrier gear to drive the first hydraulic unit, and a ring gear that is rotated by the carrier gear and coupled to the second shaft to drive the second shaft.

Clause 30: The powertrain according to any preceding clause, further including a fourth hydraulic unit fluidly connected to the second and third hydraulic units, wherein the first and fourth hydraulic units are mounted on a fourth shaft driven by the prime mover.

Clause 31: The powertrain according to clause 30, further including a directional control valve between a first side of the first hydraulic unit and the hydraulic accumulator selectively connecting the first hydraulic unit to the hydraulic accumulator to charge the hydraulic accumulator.

Clause 32: The powertrain according to clause 30 or 31, wherein the fourth shaft is rotatable to drive the first hydraulic unit to charge the accumulator and to drive the fourth hydraulic unit to pump fluid to the second and third hydraulic units.

Clause 33: The powertrain according to any preceding clause, wherein the hydraulic units are hydraulic pumps/motors.

The foregoing and other features of the invention are hereinafter described in greater detail with reference to the accompanying drawings.

### BRIEF DESCRIPTION OF THE DRAWINGS

FIG. 1 is a schematic illustration of an exemplary hydraulic hybrid powertrain according to the invention.

FIG. 2 is a schematic illustration of the hydraulic hybrid powertrain of FIG. 1 showing a hydrostatic driving mode.

FIG. 3 is a schematic illustration of the hydraulic hybrid powertrain of FIG. 1 showing a hybrid driving mode.

FIG. 4 is a schematic illustration of the hydraulic hybrid powertrain of FIG. 1 showing a direct driving mode.

FIG. 5 is a schematic illustration of the hydraulic hybrid powertrain of FIG. 1 showing a reverse driving mode. FIG. 6 is a schematic illustration of the hydraulic hybrid powertrain of FIG. 1 showing a braking mode.

FIG. 7 is a schematic illustration of another exemplary hydraulic hybrid powertrain according to the invention.

FIG. 8 is a schematic illustration of the hydraulic hybrid powertrain of FIG. 7 including gearing to directly drive wheels of the powertrain in forward or reverse.

FIG. 9 is a schematic illustration of still another exemplary hydraulic hybrid powertrain according to the invention.

FIG. 10 is a schematic illustration of yet another exemplary hydraulic hybrid powertrain according to the invention.

FIG. 11 is a schematic illustration of another exemplary hydraulic hybrid powertrain according to the invention.

FIG. 12 is a schematic illustration of yet another exemplary hydraulic hybrid powertrain according to the invention.

### DETAILED DESCRIPTION

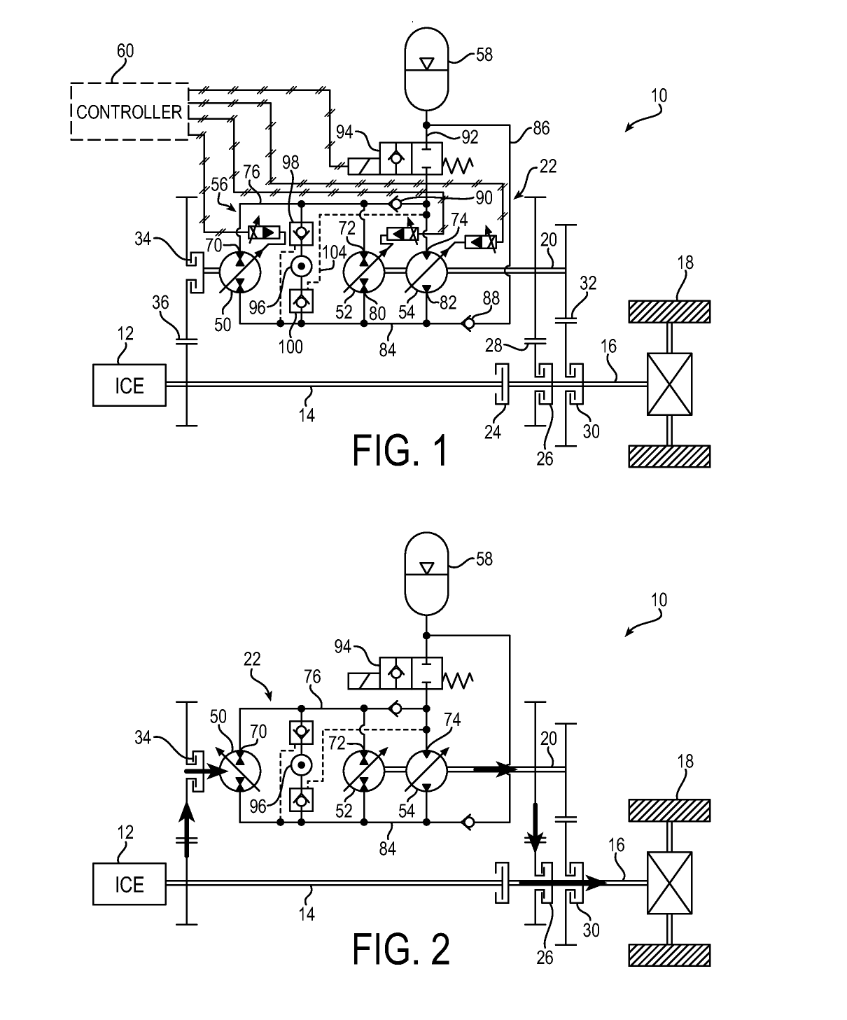

Referring to the drawings, and initially to FIG. 1, an exemplary hydraulic hybrid powertrain is illustrated generally at reference numeral 10. The hydraulic hybrid powertrain 10 includes a prime mover 12, such as an internal combustion engine, a first shaft 14 rotatably driven by the prime mover 12, a second shaft 16 coupled to at least one drive wheel 18 and selectively coupled to the first shaft 14, a third shaft 20 selectively coupled to the second shaft 16, and a hydrostatic system 22 selectively coupled to the first shaft 14. The first shaft 14 is selectively coupled to the second shaft 16 by a first clutch 24, the second shaft 16 is selectively coupled to the third shaft 20 by a second clutch 26 and a gear ratio 28 or a third clutch 30 and a gear ratio 32, and the hydrostatic system 22 is selectively coupled to the first shaft 14 by a fourth clutch 34 and a gear ratio 36. Although two clutches 26 and 30 and gear ratios 28 and 32 are shown, it will be appreciated that any suitable number of clutches and gear ratios may be provided. The clutches 24, 26, 30, and 34 are shown disengaged in FIG. 1.

The hydrostatic system 22 includes a first hydraulic unit 50 selectively coupled to the first shaft 14 through the fourth clutch 34 and gear ratio 36 to be driven by the prime mover 12, second and third hydraulic units 52 and 54 each mounted on the third shaft 20, a hydraulic circuit 56 fluidly connecting the first hydraulic unit 50 to the second and third hydraulic units 52 and 54, and a hydraulic accumulator 58, such as a high pressure accumulator fluidly connected to the hydraulic circuit to connect the accumulator 58 to the first hydraulic unit 50 and the third hydraulic unit 54. The hydraulic units 50, 52, and 54 and valves, such as valve 94 discussed below, may be controlled by a suitable electric controller 60. For example, the controller 60 may control the displacement of the units 50, 52 and 54 and the position of the valve 94. The first and second hydraulic units 50 and 52 may be any suitable units, such as a variable displacement overcenter pumps/motors operable in forward and reverse, and the third hydraulic unit 56 may be any suitable unit, such as a motor. The hydraulic circuit 56 may be any suitable means for fluidly connecting the components, such as hoses, tubes, etc., and for ease of discussion will herein be referred to as hydraulic lines.

A first side 70 of the first hydraulic unit 50 is fluidly connected to first sides 72 and 74 of the second and third hydraulic units 52 and 54, respectively, via line 76, and a second side 78 of the first hydraulic unit 50 is fluidly connected to second sides 80 and 82 of the second and third hydraulic units 52 and 54, respectively, via line 84. Line 86 is provided between line 84 and the hydraulic accumulator 58 to fluidly connect the second side 78 of the first hydraulic unit 50 to the hydraulic accumulator 58, and a check valve 88 is provided between lines 84 and 86 to prevent fluid flow from the hydraulic accumulator 56 to the line 84. Another check valve 90 is provided along line 76 to allow fluid flow from the first side 70 of the first hydraulic unit 50 to the first side 74 of the third hydraulic unit 54 while preventing fluid flow from the first side 74 of the third hydraulic unit 54 and the hydraulic accumulator 58 towards the first and second hydraulic units 50 and 52.

The first side 74 of the third hydraulic unit 54 is connected to the hydraulic accumulator 58 via line 92, and a valve 94, such as an on/off check valve is provided along line 92. The valve 94 isolates the hydraulic accumulator 58 from the third hydraulic unit 54 during a first mode (hydrostatic driving mode) when the first hydraulic unit 50 is driving the second and third hydraulic units 52 and 54, and allows for fluidic communication between the hydraulic accumulator 58 and the first side 74 of the third hydraulic unit 54 during a second or third mode (hybrid driving mode). In the second mode, the third hydraulic unit 54 is driven by fluid from the hydraulic accumulator 58 when the second hydraulic unit 52 is not driven, and in the third mode the third hydraulic unit 54 is driven by fluid from the hydraulic accumulator 58 at the same time that the second hydraulic unit 52 is driven by fluid from the first hydraulic unit 50.

A low pressure source 96 that includes a reservoir, charge pump, pressure relief valve, low pressure accumulator, filter, and oil cooler is connected between lines 76 and 84 through pilot operated check valves 98 and 100, respectively. The pilot operated check valve 98 is also connected to the line 84 via line 102 and the pilot operated check valve 100 is also connected to line 92 via line 104. The low pressure source 96 supplies fluid to whichever line is in low pressure to prevent cavitation and also provides/absorbs any extra flow to make up for the difference between supply and return, and the pilot operated check valves 98 and 100 prevent flow from the high pressure line to the low pressure line.

Turning now to FIG. 2, the hydrostatic driving mode is shown where the hydrostatic system 22 drives the wheels 18. In the hydrostatic driving mode, the first shaft 14 is coupled to the first hydraulic unit 50 by the fourth clutch 34, one of the second or third clutches 26 or 30 is engaged (the second clutch 26 is shown engaged) to connect the third shaft 20 to the second shaft 16 to drive the wheels 18, and the valve 94 is off to prevent fluid from flowing from the hydraulic accumulator 58 to the third hydraulic unit 54. The first hydraulic unit 50 is driven by the prime mover 12 to pump hydraulic fluid from the first side 70 of the unit through line 76 to the first sides 72 and 74 of the second and third hydraulic units 52 and 54, which act as motors to drive the third shaft 20, and the low pressure source 96 is connected to the line 84. The hydraulic units 52 and 54 rotate at a speed determined by the flow from line 76 and their displacements. If clutch 30 was engaged, a different speed range would be provided.

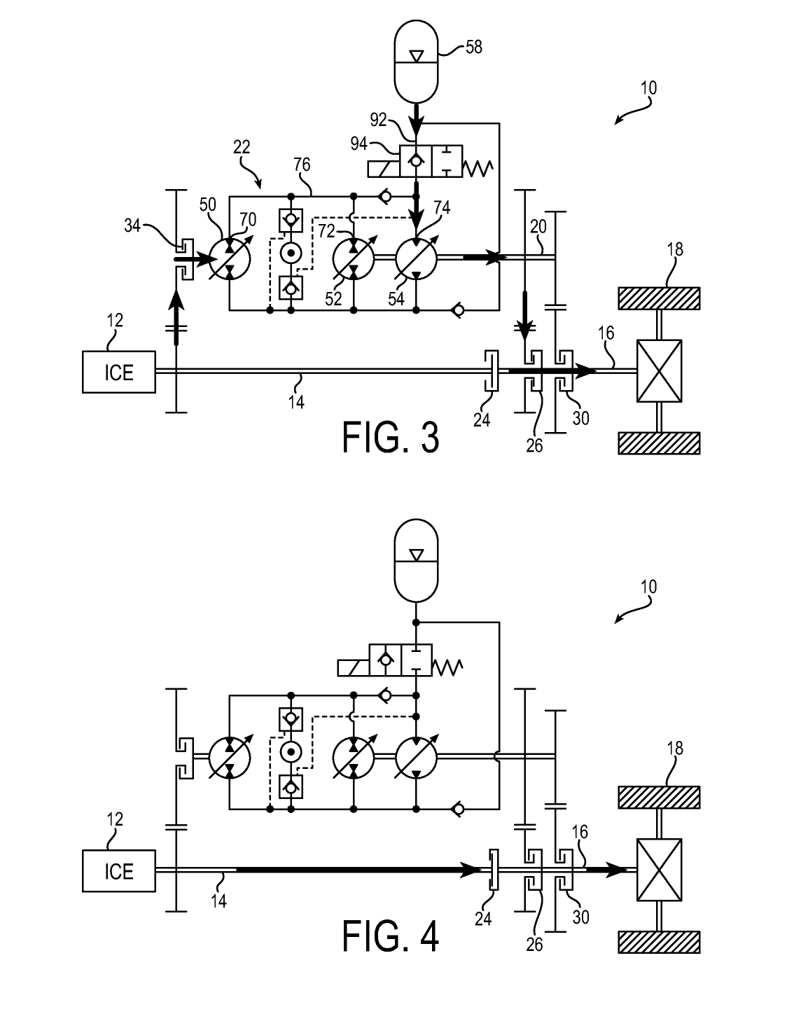

Turning now to FIG. 3, the third mode or hybrid driving mode is shown where the hydrostatic system 22 drives the wheels 18. In the hydrostatic driving mode, the first shaft 14 is coupled to the first hydraulic unit 50 by the fourth clutch 34, one of the second or third clutches 26 or 30 is engaged (the second clutch 26 is shown engaged) to connect the third shaft 20 to the second shaft 16 to drive the wheels 18, and the valve 94 is on to allow fluid flow from the hydraulic accumulator 58 to the first side 74 of the third hydraulic unit 54. The controller 60 is provided to control the foregoing to cause the third hydraulic unit 54 to be driven by fluid from the hydraulic accumulator 58 at the same time that the second hydraulic unit 52 is driven by fluid from the first hydraulic unit 50. The first hydraulic unit 50 is driven by the prime mover 12 to pump hydraulic fluid from the first side 70 of the unit through line 76 to the first side 72 of the second hydraulic unit 52, and the hydraulic accumulator 58 supplies pressurized fluid to the first side 74 of the third hydraulic unit 54. The second and third hydraulic units 52 and 54 act as motors to drive the third shaft 20 at a higher torque than if driven by the hydraulic unit 50 alone. The vehicle may operate in the third mode as long as the pressure of the fluid in line 92 is higher than the pressure in line 76 to prevent fluid flow from line 76 through the check valve 90. Similarly, in the second mode, the hydraulic accumulator 58 supplies pressurized fluid to the first side 74 of the hydraulic unit 54, which acts as a motor to drive the third shaft 20, while no fluid is provided to the second hydraulic unit 52.

Turning now to FIG. 4, a direct driving mode is shown where the prime mover 12 is directly mechanically linked to the wheels 18. As shown, the first shaft 14 is coupled to the second shaft 16 by the first clutch 24, the second and third clutches 26 and 30 are not engaged and the fourth clutch 34 is not engaged thereby isolating the hydrostatic system 22 from the prime mover 12. The prime mover 12 may be used to directly drive the wheels 18 in any suitable condition, such as when the vehicle is operating at high cruising speeds, thereby avoiding losses associated with hydraulic units.

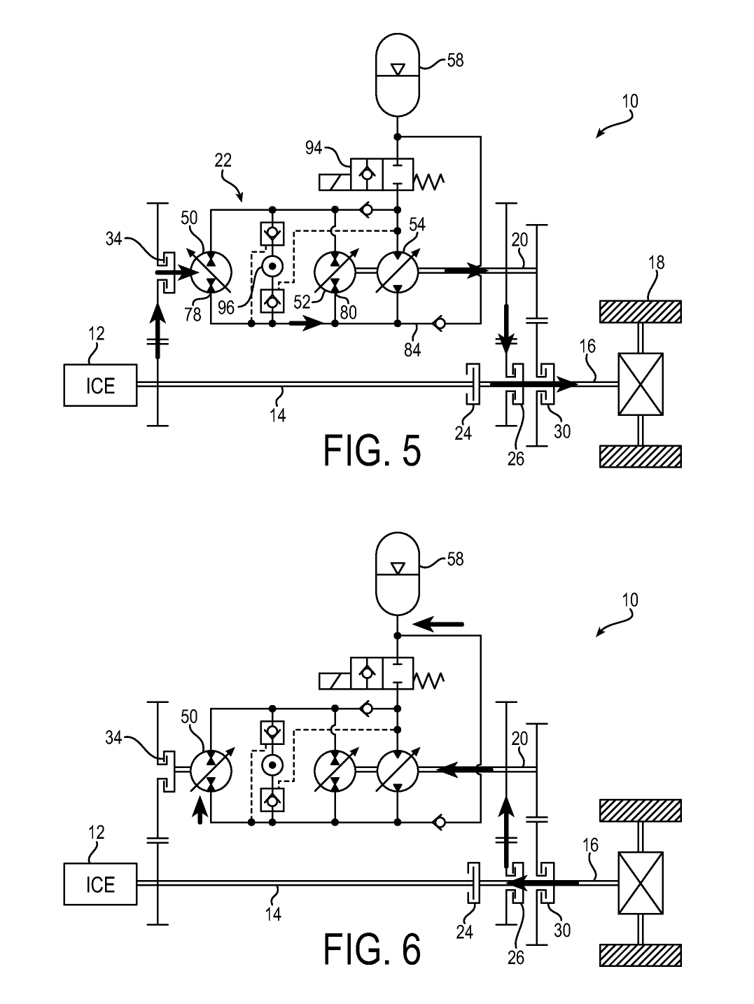

Turning now to FIG. 5, a reverse driving mode is shown where the hydrostatic system 22 drives the wheels 18 in reverse. In the reverse driving mode, the first shaft 14 is coupled to the first hydraulic unit 50 by the fourth clutch 34, one of the second or third clutches 26 or 30 is engaged (the second clutch 26 is shown engaged) to connect the third shaft 20 to the second shaft 16 to drive the wheels 18, and the valve 94 is off to prevent fluid from flowing from the hydraulic accumulator 58 to the third hydraulic unit 54. The first hydraulic unit 50 is moved overcenter and driven by the prime mover 12 to pump hydraulic fluid from the second side 78 of the unit through line 84 to the second side 80 of the second hydraulic unit 52, which acts as a motor to drive the third shaft 20, and the low pressure source 96 is connected to the line 76. The hydraulic unit 52 rotates at a speed determined by the flow from line 84 and its displacement. If clutch 30 was engaged, a different speed range would be provided. During braking, recovered energy can either be used to power auxiliary components powered by the hydraulic unit 50. The hydraulic unit 50 can also be run in reverse to pump hydraulic fluid from line 84 through the check valve 88 to line 86 to charge the hydraulic accumulator 58.

Turning now to FIG. 6, a braking mode is shown in the forward driving direction where braking energy is captured. In the braking mode, the first shaft 14 is coupled to the first hydraulic unit 50 by the fourth clutch 34, one of the second or third clutches 26 or 30 is engaged (the second clutch 26 is shown engaged) to connect the third shaft 20 to the second shaft 16 to drive the wheels 18, the valve 94 is off to prevent fluid from flowing from the hydraulic accumulator 58 to the third hydraulic unit 54, the line 84 is the high pressure line and the line 76 is the low pressure line. The braking torque from the wheels 18 drives the second and third hydraulic units 52 and 54, which act as pumps to pump hydraulic fluid to the first hydraulic unit 50 to power accessories and/or to pump hydraulic fluid to the hydraulic accumulator 58 to charge the accumulator when the pressure of the fluid opens the check valve 88.

By being able to isolate the hydraulic accumulator 58 from the hydrostatic system 22, the hydrostatic system 22 may be operated using optional power management of the prime mover to increase energy efficiency, operated at lower pressures, and sluggish system response may be prevented. The hydraulic accumulator 58 and brake regeneration may then be utilized in certain situations to further increase energy efficiency.

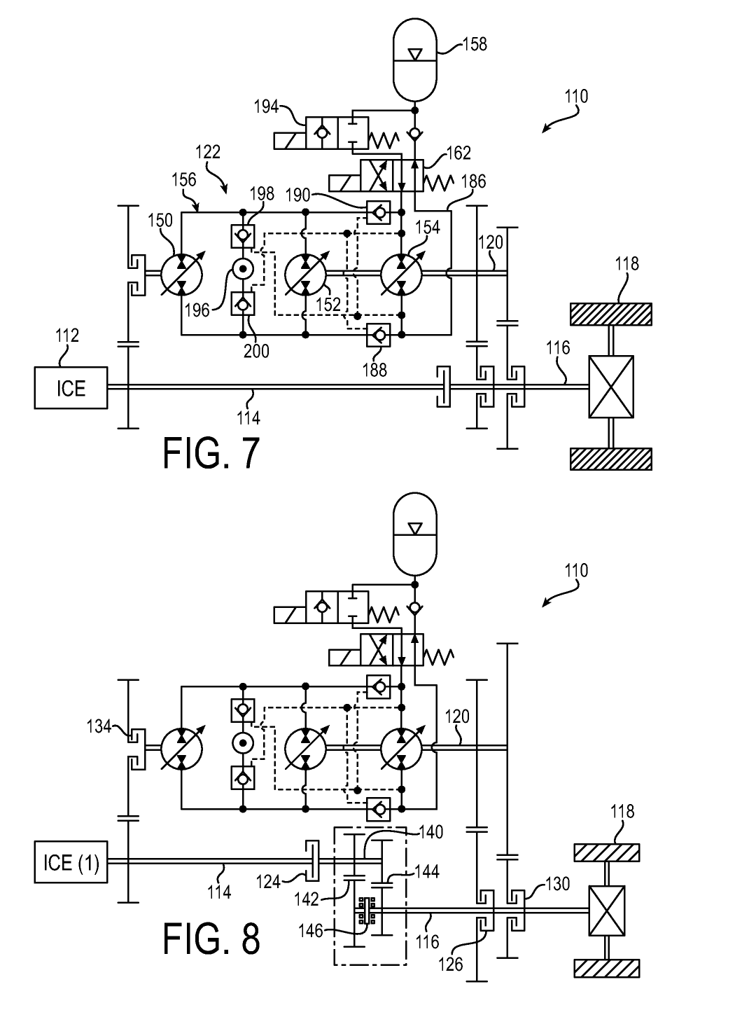

Turning now to FIG. 7, an exemplary embodiment of the hybrid powertrain is shown at 110. The hybrid powertrain 110 is substantially the same as the above-referenced hybrid powertrain 10, and consequently the same reference numerals but indexed by 100 are used to denote structures corresponding to similar structures in the hybrid powertrains. In addition, the foregoing description of the hybrid powertrain 10 is equally applicable to the hybrid powertrain 110 except as noted below. Moreover, it will be appreciated upon reading and understanding the specification that aspects of the hybrid powertrains may be substituted for one another or used in conjunction with one another where applicable.

The hydraulic hybrid powertrain 110 includes a prime mover 112, a first shaft 114 rotatably driven by the prime mover 112, a second shaft 116 coupled to at least one drive wheel 118 and selectively coupled to the first shaft 114, a third shaft 120 selectively coupled to the second shaft 116, and a hydrostatic system 122 selectively coupled to the first shaft 114. The hydrostatic system 122 includes a first hydraulic unit 150 selectively coupled to the first shaft 114, second and third hydraulic units 152 and 154 each mounted on the third shaft 120, a hydraulic circuit 156, a hydraulic accumulator 158, check valves 188 and 190, an on/off check valve 194, a low pressure source 196, and pilot operated check valves 198 and 200. The first, second, and third hydraulic units 150, 152 and 154 may be any suitable units, such as a variable displacement overcenter pumps/motors operable in forward and reverse, allowing for full prime mover power and energy recovery in forward and reverse.

The hydrostatic system 122 also includes a valve 162 controlled by a controller, such as a directional control valve between the on/off check valve 194 and the third hydraulic unit 154 and between the hydraulic accumulator 158 and the first hydraulic unit 150. The directional control valve 162 connects the second and third hydraulic units 152 and 154 to the hydraulic accumulator 158 when braking in reverse to charge the hydraulic accumulator 158. The directional control valve 162 also connects line 186 to the hydraulic accumulator 158 to connect the second and third hydraulic units 152 and 154 to the hydraulic accumulator 158 when braking in forward to charge the hydraulic accumulator 158. The directional control valve 162 may also connect the first hydraulic unit 150 to the hydraulic accumulator 158 in forward to charge the accumulator.

Turning now to FIG. 8, the powertrain 110 additionally includes a fourth shaft 140 selectively coupled to the first shaft 114 by the first clutch 124, a forward gear set 142 coupling the fourth shaft 140 to the second shaft 116, a reverse gear set 144 coupling the fourth shaft 140 to the second shaft 116, and a dog clutch 146 shown in a neutral position that engages one of the gear sets 142 and 144. In the direct driving mode, the first shaft 114 is coupled to the fourth shaft 140 by the first clutch 124, the second, third, and fourth clutches 126, 130, and 134 are disengaged, and the dog clutch 146 engages one of the gear sets 142 or 144. When the dog clutch 146 engages the gear set 142, the wheels 118 may be directly driven by the prime mover 112 in forward and when the dog clutch 146 engages the gear set 144, the wheels 118 may be directly driven by the prime mover 112 in reverse.

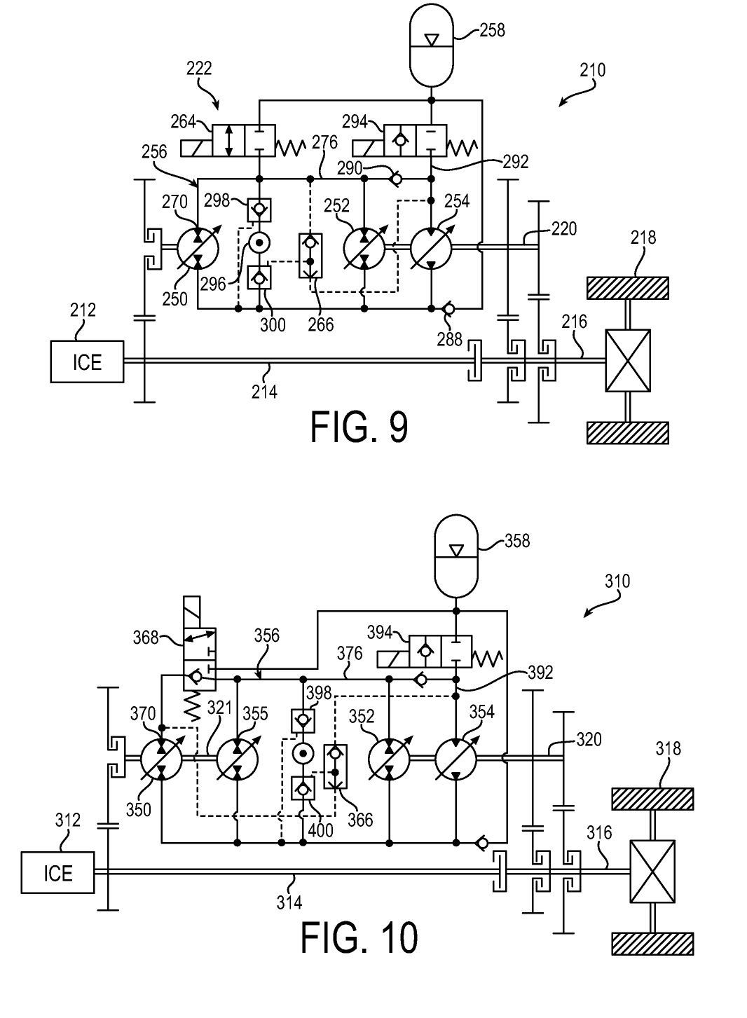

Turning now to FIG. 9, an exemplary embodiment of the hybrid powertrain is shown at 210. The hybrid powertrain 210 is substantially the same as the above-referenced hybrid powertrain 10, and consequently the same reference numerals but indexed by 200 are used to denote structures corresponding to similar structures in the hybrid powertrains. In addition, the foregoing description of the hybrid powertrain 10 is equally applicable to the hybrid powertrain 210 except as noted below. Moreover, it will be appreciated upon reading and understanding the specification that aspects of the hybrid powertrains may be substituted for one another or used in conjunction with one another where applicable.

The hydraulic hybrid powertrain 210 includes a prime mover 212, a first shaft 214 rotatably driven by the prime mover 212, a second shaft 216 coupled to at least one drive wheel 218 and selectively coupled to the first shaft 214, a third shaft 220 selectively coupled to the second shaft 216, and a hydrostatic system 222 selectively coupled to the first shaft 214. The hydrostatic system 222 includes a first hydraulic unit 250 selectively coupled to the first shaft 214, second and third hydraulic units 252 and 254 each mounted on the third shaft 220, a hydraulic circuit 256, a hydraulic accumulator 258, check valves 288 and 290, an on/off check valve 294, a low pressure source 296, and pilot operated check valves 298 and 300.

The hydrostatic system 222 also includes a valve 264 controlled by a controller, such as an on/off valve between the first side 270 of the first hydraulic unit 250 and the hydraulic accumulator 258 to selectively fluidly connect the hydraulic unit 250 and the hydraulic accumulator 258, and a shuttle valve 266 connected to the check valve 300, line 276 and line 292. When the valve 264 is on and the prime mover 212 off, the hydraulic accumulator 258 supplies pressurized fluid to the first side 270 of the first hydraulic unit 250, which acts as a motor to power accessories and/or to start the prime mover 212. When the valve is on and the prime mover 212 powering the hydraulic unit 250, excess energy may be delivered to the hydraulic accumulator 258 to charge the accumulator for future load leveling, or pressurized fluid provided through the valve 264 to line 276 to power the second and third hydraulic units 252 and 254.

Turning now to FIG. 10, an exemplary embodiment of the hybrid powertrain is shown at 310. The hybrid powertrain 310 is substantially the same as the above-referenced hybrid powertrain 10, and consequently the same reference numerals but indexed by 300 are used to denote structures corresponding to similar structures in the hybrid powertrains. In addition, the foregoing description of the hybrid powertrain 10 is equally applicable to the hybrid powertrain 310 except as noted below. Moreover, it will be appreciated upon reading and understanding the specification that aspects of the hybrid powertrains may be substituted for one another or used in conjunction with one another where applicable.

The hydraulic hybrid powertrain 310 includes a prime mover 312, a first shaft 314 rotatably driven by the prime mover 312, a second shaft 316 coupled to at least one drive wheel 318 and selectively coupled to the first shaft 314, a third shaft 320 selectively coupled to the second shaft 316, and a hydrostatic system 322 selectively coupled to the first shaft 314. The hydrostatic system 322 includes a first hydraulic unit 350 selectively coupled to the first shaft 314, second and third hydraulic units 352 and 354 each mounted on the third shaft 320, a hydraulic circuit 356, a hydraulic accumulator 358, check valves 388 and 390, an on/off check valve 394, a low pressure source 396, and pilot operated check valves 398 and 400.

The hydrostatic system 322 also includes a fourth hydraulic unit 355 mounted on a fourth shaft 321 with the first hydraulic unit 350 and controlled by a controller, a valve 368 controlled by the controller, such as a directional control valve between the first side 370 of the first hydraulic unit 350 and the hydraulic accumulator 358 selectively connecting the first hydraulic unit to the hydraulic accumulator, and a shuttle valve 366 connected to the check valve 400, line 376 and line 392. The first and fourth hydraulic units 350 and 355 may be any suitable units, such as a variable displacement overcenter pumps/motors operable in forward and reverse, which may be smaller in size than the first hydraulic unit 50 of FIG. 1. The fourth shaft 321 may be rotated by the prime mover 312 to drive the first and fourth hydraulic units 350 and 355 to drive the second and third hydraulic units 352 and 354 when the valve is connected as shown. The valve 368 may also be controlled to connect the first side 370 of the first hydraulic unit 350 to the hydraulic accumulator 358. When the hydraulic unit 350 is connected to the hydraulic accumulator 358, the fourth shaft 321 drives the first hydraulic unit 350 to deliver excess energy to the hydraulic accumulator 358 to charge the accumulator for load leveling, and drives the fourth hydraulic unit 355 to drive the second and third hydraulic units 352 and 354.

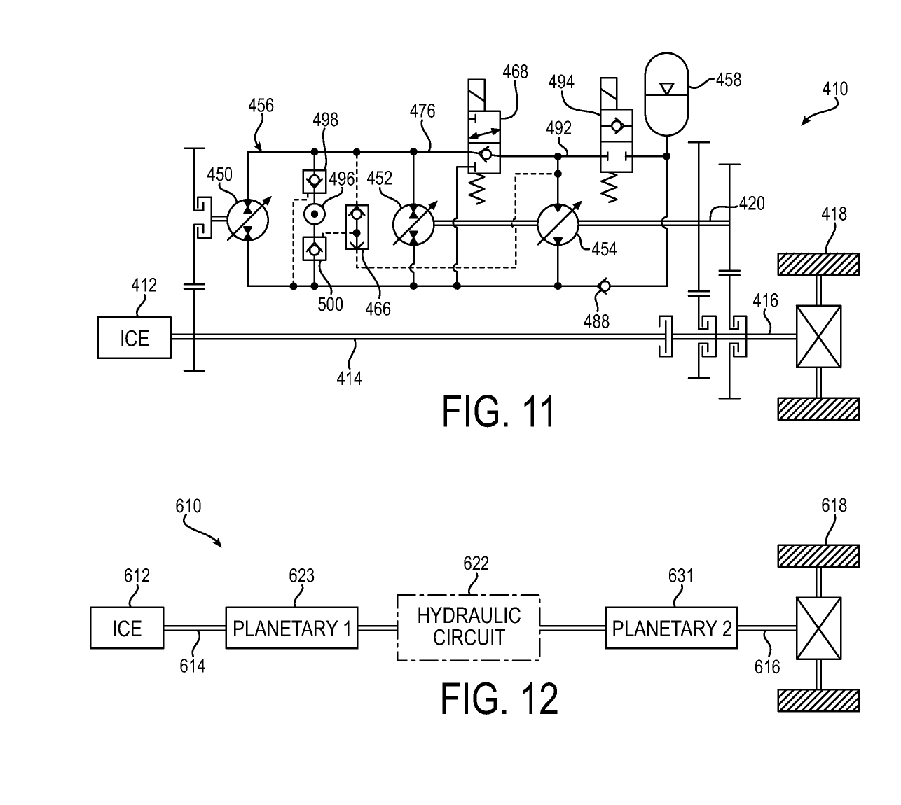

Turning now to FIG. 11, an exemplary embodiment of the hybrid powertrain is shown at 410. The hybrid powertrain 410 is substantially the same as the above-referenced hybrid powertrain 10, and consequently the same reference numerals but indexed by 400 are used to denote structures corresponding to similar structures in the hybrid powertrains. In addition, the foregoing description of the hybrid powertrain 10 is equally applicable to the hybrid powertrain 410 except as noted below. Moreover, it will be appreciated upon reading and understanding the specification that aspects of the hybrid powertrains may be substituted for one another or used in conjunction with one another where applicable.

The hydraulic hybrid powertrain 410 includes a prime mover 412, a first shaft 414 rotatably driven by the prime mover 412, a second shaft 416 coupled to at least one drive wheel 418 and selectively coupled to the first shaft 414, a third shaft 420 selectively coupled to the second shaft 416, and a hydrostatic system 422 selectively coupled to the first shaft 414. The hydrostatic system 422 includes a first hydraulic unit 450 selectively coupled to the first shaft 414, second and third hydraulic units 452 and 454 each mounted on the third shaft 420, a hydraulic circuit 456, a hydraulic accumulator 458, check valve 488, an on/off check valve 494, a low pressure source 496, pilot operated check valves 498 and 500, and a shuttle valve 466 connected to the check valve 500, line 476 and line 492.

The hydrostatic system 422 also includes a valve 468 controlled by a controller, such as a directional control valve between the second and third hydraulic units 452 and 454 along line 476 selectively connecting the third hydraulic unit 454 to the line 476. The valve 468 allows fluid flow through line 476 to the third hydraulic unit 454 when connected so that fluid drives the second and third hydraulic units 452 and 454 as shown, and prevents fluid flow from the first side 474 of the third hydraulic unit 454 and the hydraulic accumulator 458 past the valve 468. The valve 468 may be controlled to disconnect the line 476 from the third hydraulic unit 454 to isolate the unit 454 from high pressure so that the hydraulic unit 452 solely drives the third shaft 420, for example when the hydraulic unit 452 is capable of supplying the demanded power at the wheels 418.

Turning now to FIG. 12, an exemplary embodiment of the hybrid powertrain is shown at 610. The hybrid powertrain 610 is substantially the same as the above-referenced hybrid powertrain 410, and consequently the same reference numerals but indexed by 200 are used to denote structures corresponding to similar structures in the hybrid powertrains. In addition, the foregoing description of the hybrid powertrain 410 is equally applicable to the hybrid powertrain 610 except as noted below. Moreover, it will be appreciated upon reading and understanding the specification that aspects of the hybrid powertrains may be substituted for one another or used in conjunction with one another where applicable.

The hydraulic hybrid powertrain 610 may include a dual stage power split transmission. The hydraulic hybrid powertrain 610 includes a prime mover 612, a first shaft 614 rotatably driven by the prime mover 612, a second shaft 616 coupled to at least one drive wheel 618 and coupled to the first shaft 614 through first and second planetary gear trains 623 and 631, and a hydrostatic system 622. The hydrostatic system 622 may be any of the above described hydrostatic systems.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hydrostatic system including:
a first hydraulic unit configured to be driven by a prime mover;
a first shaft;
a second shaft that that is selectively coupleable to the first shaft through a first pair of gears, and that is connectable to one or more wheels;
a second hydraulic unit mounted on the first shaft and being fluidly connected to the first hydraulic unit;
a third hydraulic unit mounted on the first shaft and being fluidly connected to the first hydraulic unit; and
a hydraulic accumulator fluidly connected to the first hydraulic unit and the third hydraulic unit.

2. The hydrostatic system according to claim 1, further including a controller configured to cause the third hydraulic unit to be driven by fluid from the accumulator at the same time that the second hydraulic unit is driven by fluid from the first hydraulic unit.

3. The hydrostatic system according to claim 1, wherein the second and third hydraulic units each have a first side fluidly connected to a first side of the first hydraulic unit, and wherein the first side of the third hydraulic unit is fluidly connected to the hydraulic accumulator.

4. The hydrostatic system according to claim 1, wherein the second hydraulic unit has a second side fluidly connected to a second side of the first hydraulic unit for driving the first shaft in reverse.

5. The hydrostatic system according to claim 1, wherein the first hydraulic unit has a second side fluidly connected to the hydraulic accumulator.

6. The hydrostatic system according to claim 1, further including a valve between the accumulator and the first side of the third hydraulic unit for isolating the accumulator from the third hydraulic unit during a hydrostatic driving condition and for allowing fluidic communication between the accumulator and third hydraulic unit during a hybrid driving condition.

7. The hydrostatic system according to claim 6, wherein the valve is an on/off check valve.

8. The hydrostatic system according to claim 1, further including a valve between the first side of the first hydraulic unit and the hydraulic accumulator, wherein when the valve is open the accumulator and the first side of the first hydraulic unit are fluidly connected.

9. The hydrostatic system according to claim 1, further including a controller configured to cause the third hydraulic unit to be driven in tandem with the second hydraulic unit by fluid from the first hydraulic unit in a first operation mode, cause the third hydraulic unit to be driven by fluid from the hydraulic accumulator when the second hydraulic unit is not driven in a second operation mode, and cause the third hydraulic unit to be driven by fluid from the accumulator at the same time that the second hydraulic unit is driven by fluid from the first hydraulic unit in a third operation mode.

10. The hydrostatic system according to claim 1, wherein the hydraulic units are hydraulic pumps/motors.

11. The hydrostatic system according to claim 10, wherein the hydraulic pump/motors are bi-directional pumps/motors

12. A hydrostatic system including:
a first shaft coupleable to a prime mover;
a first hydraulic pump/motor mounted on the first shaft;
a second hydraulic pump/motor mounted on the first shaft;
a second shaft;
a third shaft that is selectively coupleable to the second shaft through a first pair of gears, and that is connectable to one or more wheels;
a third hydraulic pump/motor mounted on the second shaft and being fluidly connected to the first and second hydraulic pumps/motors;
a fourth hydraulic pump/motor mounted on the second shaft and being fluidly connected to the first and second hydraulic pumps/motors; and
a hydraulic accumulator fluidly connected to the first hydraulic pump/motor and the fourth hydraulic pump/motor.

13. A powertrain for transmitting power between a prime mover and at least one drive wheel, the powertrain including:
a first shaft rotatably coupled to the prime mover;
a second shaft coupled to the at least one drive wheel and selectively coupled to the first shaft;
a first hydraulic unit selectively coupled to the first shaft through a first pair of gears;
second and third hydraulic units each mounted on a third shaft that is selectively coupled to the second shaft through a second pair of gears;
a hydraulic circuit fluidly connecting the first hydraulic unit to the second and third hydraulic units; and
a hydraulic accumulator fluidly connected to the hydraulic circuit.

14. The powertrain according to claim 13, wherein the first shaft is selectively coupled to the second shaft by a first clutch.

15. The powertrain according to claim 13, wherein the second shaft is selectively coupled to the third shaft by second or third clutches.

16. The powertrain according to claim 13, wherein the first hydraulic unit is selectively coupled to the first shaft by a fourth clutch.

17. The powertrain according to claim 13, wherein the third shaft is selectively coupled to the second shaft through a third pair of gears.

18. The powertrain according to claim 13, wherein the first shaft is selectively coupled to the second shaft by a first clutch;wherein the second shaft is selectively coupled to the third shaft by a second clutch;
wherein the third shaft is selectively coupleable to the second shaft through a third pair of gears with a different gear ratio than the second pair of gears to provide a different speed range, and the second shaft is selectively coupleable to the third shaft by a third clutch; and
wherein the first hydraulic unit is selectively coupled to the first shaft by a fourth clutch.

19. The powertrain according to claim 1, wherein the first shaft is selectively coupleable to the second shaft through a second pair of gears.

20. The powertrain according to claim 12, wherein the third shaft is selectively coupleable to the second shaft through a second pair of gears.
